(19) United States
(12) Patent Application Publication
(10) Pub. No.: US 2005/0047056 A1
(43) Pub. Date: Mar. 3, 2005

(54) Electronic apparatus with negative ion generating device therein

(76) Inventor: Jen-Yuan Huang, Xizhi City (TW)

Correspondence Address: RABIN & Berdo, PC, 1101 14TH STREET, NW, SUITE 500, WASHINGTON, DC, 20005, US

(21) Appl. No.: 10/773,222

(22) Filed: Feb. 9, 2004

(30) Foreign Application Priority Data
Aug. 29, 2003 (TW) 92123886

(51) Int. Cl. H02H 1/00

(52) U.S. Cl. 361/212

(57) ABSTRACT

An electronic apparatus with a negative ion generating device therein. The electronic apparatus includes a motherboard and a negative ion generating device. When the motherboard operates, detrimental positive ions are generated. The negative ion generating device is disposed adjacent to the motherboard, and to generate negative ions. The positive ions are neutralized by a portion of the negative ions. Thus, adverse health issue are prevented.

### BACKGROUND OF THE INVENTION

1. Field of the Invention

The invention relates to an electronic apparatus, and in particular, the invention relates to an electronic apparatus with a negative ion generating device therein.

2. Description of the Related Art

Electronic apparatuses normally generate a certain amount of positive ions during operation, thus excessively increasing the amount of the positive ions in the surrounding air. According to research, positive ions are detrimental to humans.

Since electronic apparatuses, such as computers, are ubiquitous, it is important to address the issue of excess positive ions generated by the electronic apparatuses.

Recently, an electronic apparatus assembled with a negative ion generating device has been introduced. The negative ion generating device is, however, located outside the electronic apparatus, hence, the air quality cannot be effectively controlled. Specifically, since the positive ions generated from the electronic apparatus are released into the air, the ratio between the positive and negative ions becomes uneven in the surrounding air.

### SUMMARY OF THE INVENTION

In view of this, the invention provides an electronic apparatus with a negative ion generating device therein.

Accordingly, the invention provides an electronic apparatus including a motherboard and a negative ion generating device. When the motherboard operates, detrimental positive ions are generated. The negative ion generating device is disposed adjacent to the motherboard, to generate negative ions. The positive ions are neutralized by a portion of the negative ions. Thus, the potential damage to humans is reduced.

The negative ion generating device is disposed in the electronic apparatus, and can be located on the motherboard, an optical disc drive, a hard disk drive, a power supply, a housing, or inside the housing.

The negative ion generating device generates negative ions by dissolving air via high-voltage discharge. Alternatively, powders with rare earth elements emitting β rays can be disposed in the negative ion generating device. Since rare earth elements carry negative ions, they can continuously generate and release negative ions into the air.

If the negative ion generating device generates negative ions by high-voltage discharge, the negative ion generating device includes a high-voltage discharge terminal and a ground terminal. The high-voltage discharge terminal dissolves air to generate negative ions. The ground terminal grounds the positive ions dissolved from the air so that the amount of positive ions released from the housing can be reduced. The negative ion generating device further includes a power terminal to provide power required by the negative ion generating device for high-voltage discharge.

The electronic apparatus may include at least one fan for dissipating heat from the electronic apparatus. In addition, the fan can exhaust negative ions from the negative ion generating device out of the electronic apparatus. The fan can be disposed on a central processing unit, in a power supply, or in an opening of the housing.

### BRIEF DESCRIPTION OF THE DRAWINGS

The present invention can be more fully understood by reading the subsequent detailed description and examples with references made to the accompanying drawings, wherein:

FIG. 1 is a schematic view of an electronic apparatus as disclosed in a first embodiment of the invention;

FIG. 2 is a schematic view of a portable computer as disclosed in the invention;

FIG. 3a is a schematic view of an electronic apparatus as disclosed in a second embodiment of the invention; and

FIG. 3b is a schematic view of a power supply in FIG. 3b.

### DETAILED DESCRIPTION OF THE INVENTION

First Embodiment

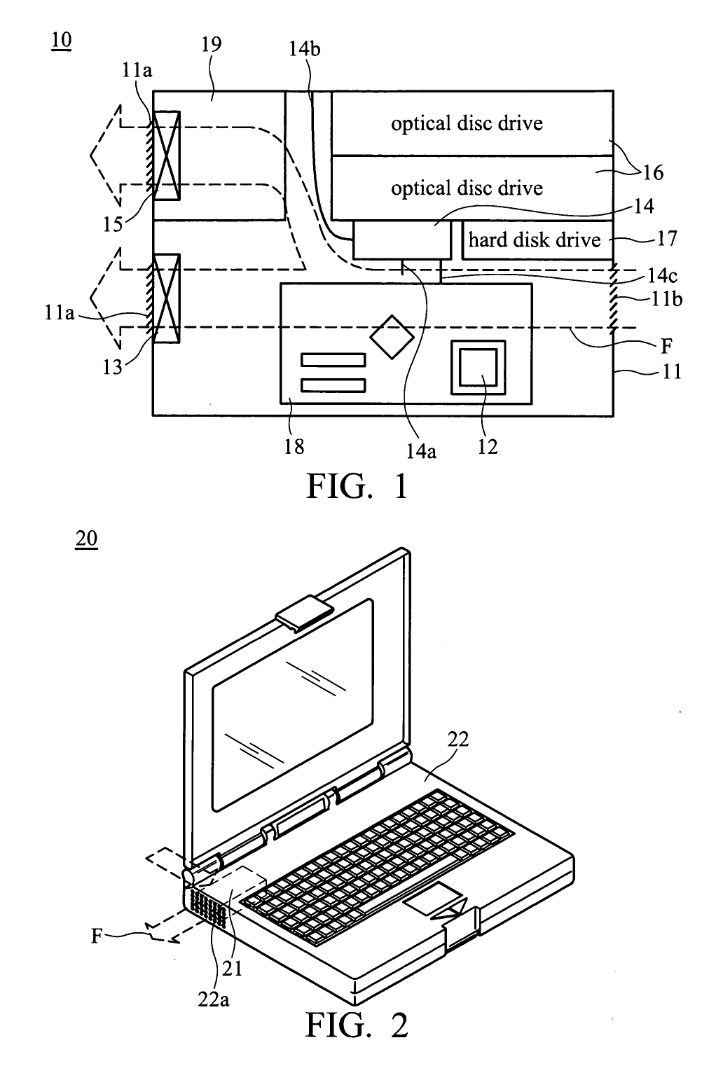

FIG. 1 is a schematic view of an electronic apparatus with a negative ion generating device as disclosed in a first embodiment of the invention. A host 10 for a computer is used as an example in this embodiment. However, the concept of the invention is not limited to this, and can be applied to other electronic apparatuses.

Referring to FIG. 1, the computer 10 includes a housing 11, a central processing unit 12, a main fan 13, a negative ion generating device 14, a fan 15 for a power supply 19, two optical disc drives 16, a hard disk drive 17, a motherboard 18, and a power supply 19. The housing 11 encloses other devices therein, and includes two exits 11a and an inlet 11b at its periphery.

The motherboard 18 is the operational center of the computer 10, and is disposed in the housing 11. When the motherboard 18 operates, positive ions are generated. The central processing unit 12, is disposed on the motherboard 18. The power supply 19 provides power required by the computer 10. Since the power supply 19 generates excessive heat during operation, the fan 15 is usually disposed on the power supply 19. The fan 15 and the main fan 13 generate an air flow F in the housing 11 to dissipate the heat from the motherboard 18 and other devices. The main fan 13 is located in the exit (opening) 11a of the housing 11.

The negative ion generating device 14 is disposed in the housing 11, and generates negative ions. The positive ions from the motherboard 18 can be neutralized by a portion of the negative ions. The negative ion generating device 14 includes a high-voltage discharge terminal 14a and a ground terminal 14b. The high-voltage discharge terminal 14a decomposes air by high-voltage and releases negative ions. The ground terminal 14b is connected to the housing 11, and guides positive ions decomposed from the air to the housing 11 so as to be grounded. Specifically, using the high voltage of the high-voltage discharge terminal 14a, the positive ions, the negative ions and NOₓ can be decomposed from the air. A portion of the positive ions can be grounded via the ground terminal 14b so as to be removed. Thus, negative ions remain in the air. Since the operational principle of the negative ion generating device by high-voltage discharge is well known in the art, its detailed description is omitted.

Furthermore, the negative ion generating device 14 includes a power terminal 14c, connected to the motherboard 18, to provide power required by the negative ion generating device 14. In addition, the power terminal 14c of the negative ion generating device 14 may be directly connected to the power supply 19, or electrically connected to the power supply 19 via the motherboard 18.

In this embodiment, the negative ion generating device 14 is disposed on the optical disc drive 16; however, it is not limited to this. The negative ion generating device 14 may be disposed on the motherboard 18 or the hard disk drive 17. Alternatively, the negative ion generating device 14 may be disposed around the main fan 13 or the fan 15. The negative ions from the negative ion generating device 14 can be exhausted via the air flow F in the housing 11.

In addition, except for the main fan 13 and the fan 15, the computer 10 may further include other fans, such as a fan disposed on the central processing unit 12.

As stated above, in the invention, the negative ion generating device is directly built-into the positive-ion generating electronic apparatus. Thus, positive ions, generated during the operation of circuits in the electronic apparatus, can be directly neutralized by the negative ions, providing the previously described health benefits of negative ions. Additionally, providing a healthy work environment may enhance efficiency.

In addition, in this embodiment, the negative ion generating device 14 is described by the high-voltage discharge; however, it is not limited to this. The negative ion generating device 14 may be a metal plate coated with rare earth element powders emitting β rays. The rare earth elements are and can emit rays, which always carry negative ions. Thus, by means of the rare earth elements, the negative ions can be continuously generated in the housing 11 so as to attain the same effect as stated above. When the negative ion generating device is a metal plate including rate earth elements, the high-voltage discharge terminal 14a, the ground terminal 14b, and the power terminal 14c as shown in FIG. 1 are not required.

Furthermore, in this embodiment, the host is used as an example to describe the electronic apparatus with the negative ion generating device, however, it is not limited to this. For example, the electronic apparatus may be a portable computer or a server. FIG. 2 shows a portable computer 20 with a negative ion generating device 21. The negative ion generating device 21 is disposed in the portable computer 20, and generates negative ions that can be exhausted to the surrounding air through an exit 22a of a housing 22.

Second Embodiment

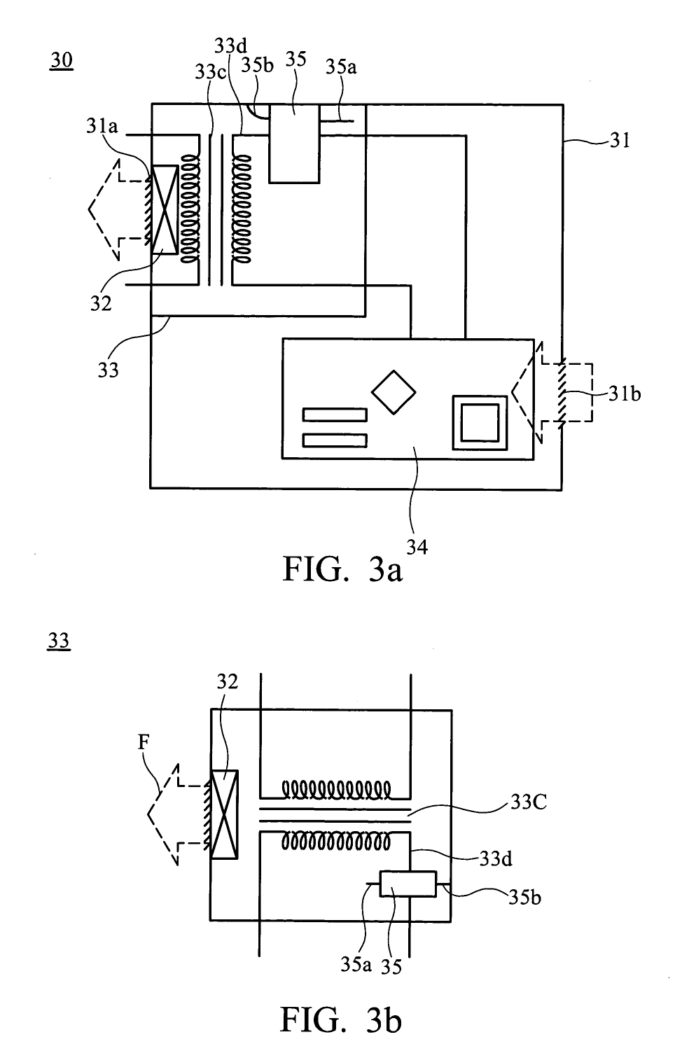

FIG. 3a and FIG. 3b are schematic views of an electronic apparatus 30 with a negative ion generating device as disclosed in a second embodiment of the invention. In this embodiment, the electronic apparatus 30 includes a housing 31, a fan 32, a power supply 33, and a motherboard 34. The fan 32 is disposed in the power supply 33, and generates an air flow in the housing 31.

This embodiment differs from the first embodiment in that a negative ion generating device 35 is built into the original power supply 33 in the electronic apparatus 30. Referring to FIG. 3a and FIG. 3b, the power supply 33 is connected to the motherboard 34, and includes a power terminal 33d and a transformer 33c. The transformer 33c transforms an external power voltage, such as an AC voltage, into a voltage for normal devices and a high-voltage for a high voltage discharge terminal 35a of the negative ion generating device 35. The high-voltage discharge terminal 35a can decompose the air and generate negative ions. The generated negative ions can be exhausted from the housing 31 by an air flow F. In addition, the negative ion generating device 35 includes a ground terminal 35b for grounding positive ions.

By the structure of this embodiment, positive ions, generated during the operation of the circuits, such as the motherboard, in the electronic apparatus, can be directly neutralized by the negative ions generated by the negative ion generating device 35. Thus, the effect of the first embodiment can be attained in this embodiment. In addition, since the negative ion generating device is built into the power supply, the original arrangement of the electronic apparatus does not require modification.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. An electronic apparatus comprising:
a motherboard generating positive ions during operation; and
a negative ion generating device for generating negative ions, wherein the positive ions are neutralized by a portion of the negative ions when the motherboard operates.

2. The electronic apparatus as claimed in claim 1, wherein the negative ion generating device is disposed on the motherboard.

3. The electronic apparatus as claimed in claim 1, wherein the electronic apparatus further includes an optical disc drive on which the negative ion generating device is disposed.

4. The electronic apparatus as claimed in claim 1, wherein the electronic apparatus further includes a hard disk drive on which the negative ion generating device is disposed.

5. The electronic apparatus as claimed in claim 1, wherein the electronic apparatus further includes a power supply in which the negative ion generating device is disposed.

6. The electronic apparatus as claimed in claim 1, further comprising a fan for generating an air flow for exhausting the negative ions.

7. The electronic apparatus as claimed in claim 6, wherein the fan is a heat-dissipating fan for the electronic apparatus.

8. The electronic apparatus as claimed in claim 6, wherein the electronic apparatus further includes a central processing unit, and the fan is a heat-dissipating fan for the central processing unit.

9. The electronic apparatus as claimed in claim 1, wherein the negative ion generating device includes rare earth elements.

10. The electronic apparatus as claimed in claim 1, wherein the negative ion generating device includes a high-voltage discharge terminal for decomposing air to generate the negative ions.

11. The electronic apparatus as claimed in claim 10, wherein the negative ion generating device further includes a ground terminal for grounding positive ions generated from the dissolved air.

12. The electronic apparatus as claimed in claim 10, wherein the negative ion generating device further includes a power terminal, connected to the motherboard, for providing power required by the negative ion generating device.

13. The electronic apparatus as claimed in claim 10, wherein the electronic apparatus further includes a power supply, and the negative ion generating device further includes a power terminal, connected to the power supply, for providing power required by the negative ion generating device.

14. The electronic apparatus as claimed in claim 1, further comprising:
a housing in which the motherboard and the negative ion generating device is disposed.

15. The electronic apparatus as claimed in claim 14, wherein the housing includes an opening, and the electronic apparatus further includes a fan disposed in the opening.

16. The electronic apparatus as claimed in claim 1, wherein the electronic apparatus is a computer.

17. The electronic apparatus as claimed in claim 1, wherein the electronic apparatus is a portable computer.

18. The electronic apparatus as claimed in claim 1, wherein the electronic apparatus is a server.
